(19) United States
(12) Patent Application Publication
(10) Pub. No.: US 2025/0336573 A1
(43) Pub. Date: Oct. 30, 2025

(54) ELECTRICAL FEEDTHROUGH ASSEMBLY WITH INSULATION ELEMENT

(71) Applicant: SCHOTT AG, Mainz (DE)

(72) Inventors: Helmut HARTL, Wien (AT); Florian BERGER, Essenbach (DE); Hauke ESEMANN, Mainz (DE); Fangtong XIE, Mainz (DE)

(21) Appl. No.: 19/193,378

(22) Filed: Apr. 29, 2025

(30) Foreign Application Priority Data
Apr. 30, 2024 (EP) 24173485.4

(51) Int. Cl. H01B 17/30; F04B 35/04; F04B 39/12

(52) U.S. Cl. CPC H01B 17/305; F04B 35/04; F04B 39/121

(57) ABSTRACT

An electrical feedthrough assembly is disclosed having a base body with at least one opening for a conductor embedded in a fixation material that is fed into each of the respective openings and sealing the respective opening. The electrical feedthrough assembly further includes an insulation element made from a material having a first glass-transition temperature t_{g1}, wherein the insulation element is affixed by an adhesive material arranged between the insulation element and the fixation material.

### CROSS REFERENCE TO RELATED APPLICATION

This application claims the benefit of priority from European Patent Application No. 24173485.4 filed on Apr. 30, 2024, the contents of which are incorporated herein by reference.

### DESCRIPTION

The invention relates to an electrical feedthrough assembly which is preferably configured as e-compressor terminal. The electrical feed through assembly comprises a base body with at least one opening for at least one conductor embedded in a fixation material that is fed into the at least one opening and sealing the respective opening, wherein said electrical feedthrough assembly further comprises at least one insulation element which is affixed by means of an adhesive material arranged between the at least one insulation element and the base body and/or the fixation material.

Housings for electronic components usually require a plurality of electrical feedthroughs in order to enable electrical connections from outside to the inner part of the housing, which accommodates e.g. parts of an electronic compressor in the housing. The electrical feedthroughs should be fluid tight or even hermetic in order to protect the components inside the housing from the environment and/or to contain gases or fluids in the housing. In order to provide such fluid-tight or hermetic feedthroughs for an electric conductor arranged in an opening of the housing, glass-to-metal seals may be used. A fixation material, for example a glass material, is used to seal the opening and to hold the conductor within the opening. The fixation material also provides an electrical insulation between the conductor and the housing.

To provide additional electrical insulation between the housing and the conductor and, if more than one conductor is present between the conductors, it is known to arrange an additional insulation element on the electrical feedthrough. The insulation element at least partially surrounds the conductor and enlarges a so-called creepage distance between a conductor and the housing and/or between two conductors. The insulation element for extending the creepage distance may be, for example, an insulating rubber or plastic sleeve or cylinder, which at least partially surrounds a conductor.

WO2022/259597A1 describes an airtight terminal having a metal base body which has at least one opening. A connecting lead is inserted through the opening and a fixation material seals said opening. The terminal further comprises an insulating cylinder having at least one peripheral groove on the outer periphery wall. The insulating cylinder is made from a heat-resistant and oil/refrigerant-resistant elastic rubber or plastic material and which is airtightly adhered to the fixation material or the base body via an adhesive layer. Suitable plastic materials for the insulating cylinder include PBT (polybutylene terephthalate), PPS (polyphenylene sulfide), or PEEK (polyetheretherketone). Suitable rubber materials include HNBR (hydrogenated nitrile rubber) or EPDM (ethylene-propylene-diene rubber). For bonding insulating cylinders made from PPS and EPDM an epoxy adhesive is used.

Adhesive bonding of an insulation element such as an insulating cylinder provides an easy and quick way for attaching insulation elements to a base body or a fixation material of an electrical feedthrough assembly. However, it has been found that it is difficult to ensure a good bond between insulating materials, in particular rubber materials, and the used adhesive that remains airtight and mechanically stable over time. It has been found that in particular at low temperatures the insulation elements exert stress onto the interface between the adhesive material and the fixation material. This is in particular caused by the fact that the material of the insulation element and the adhesive material are hard and not resilient at low temperatures, in particular at temperatures below the respective glass transition temperature. This stress or strain can lead to the formation of gaps. Additionally, the gaps at the interfaces caused by the strain can be infiltrated by oils and other operating media which further weakens the bond. The insulation properties are compromised and undesired short circuits may occur.

Accordingly, it is an object of the present invention to provide a feedthrough assembly and a method for manufacturing of such a feedthrough assembly wherein the stability and reliability of an adhesive bond between an insulation element and a base body and/or fixation material is improved.

### DISCLOSURE OF THE INVENTION

An electrical feedthrough assembly which is preferably configured as e-compressor terminal is proposed. The electrical feedthrough assembly comprises a base body with at least one opening for at least one conductor embedded in a fixation material that is fed into each of the respective openings and seals the respective opening, wherein said electrical feedthrough assembly further comprises at least one insulation element made from made from an ethylene propylene diene monomer (EPDM) rubber, a hydrogenated nitrile-butadiene rubber (HNBR), a nitrile-butadiene rubber (NBR) or a fluoroelastomer material (FKM), wherein the at least one insulation element is affixed by means of an adhesive material arranged between the at least one insulation element and fixation material and optionally between the at least one insulation element and the base body, wherein the adhesive material is electrically insulating. Within an operating temperature range of from −45° C. to 120° C., preferably from −55° C. to 150° C., an absolute value of the difference between a first coefficient of thermal expansion of the adhesive material α1 and a second coefficient of thermal expansion of the fixation material α2 is in the range of from 10·10⁻⁶ K⁻¹ to 180·10⁻⁶ K⁻¹. For temperatures below the glass transition temperature of the adhesive material, the difference is preferably from 10·10⁻⁶ K⁻¹ to 90·10⁻⁶ K⁻¹, and for temperature above the glass transition temperature of the adhesive material, the difference is preferably from 30·10⁻⁶ K⁻¹ to 180·10⁻⁶ K⁻¹.

Further, if the adhesive material is laterally enclosed by a sidewall, lateral expansion of the adhesive material is restricted, the adhesive material has a thickness of between 0.3 mm and 1.0 mm, preferably between 0.4 and 0.8 mm, and if the adhesive material is not laterally enclosed, so that lateral expansion of the adhesive material is possible, the adhesive material has a thickness of between 0.1 mm and 0.6 mm, preferably between 0.2 mm and 0.4 mm. In the latter case, the adhesive material is preferably arranged on an essentially flat surface formed by the fixation material and/or the base body, wherein the adhesive material covers only a part of the essentially flat surface and thus allowing thermal expansion of the adhesive in lateral direction. In the first case, the adhesive material may also be arranged on an essentially flat surface formed by the fixation material and/or the base body, but the adhesive material directly touches side walls so that the adhesive is laterally enclosed.

The insulation element is preferably arranged over the conductors such that a cylindrical section of the insulation element at least partially surrounds the respective conductor. By ensuring a gap-free and preferably air-tight connection between the insulation element and the base body and/or the fixation material, the insulation element increases an electrical insulation distance or creeping distance between a conductor and the base body and/or between two conductors of the assembly. Thus, the insulation element contributes to reduce the risk of short circuits, especially in case of wet or humid environments. In such environments, a water layer and/or dirt layer or the like might deposit on the surfaces of the feed-through assembly, in particular on a surface of the fixation material insulating a conductor from the base body. Such a water film wetting the materials of the feedthrough assembly can in particular occur easily in an e-compressor with the feedthrough assembly configured as an e-compressor terminal. This is because the e-compressor has a very low temperature e.g. of lower than e.g. 5° C. or even negative temperatures, whereas the ambient temperature e.g. in the summertime might be higher than 20° C. In such a case, a water film may form due to condensation. By additionally insulating the conductor from the material of the base body and thus from a housing of a device comprising the feedthrough assembly, for example in e-compressor applications, short circuits due to conductive water and/or dirt films can be prevented.

Preferably, the base body and the fixation material form a pocket to receive the adhesive material. Such a pocket has sidewalls which restrict the flow of the adhesive material prior to curing and may be used to reduce the risk of adhesive material flowing onto sealing surfaces of the base body. However, the sidewalls of the pocket will mechanically restrict lateral thermal expansion of the adhesive material. Preferably, the adhesive material fully coves a bottom surface of the pocket, which is preferably flat. The bottom surface of the pocket is preferably provided by the fixation material and optionally a part of the base body.

In order to allow any air bubbles within the adhesive material received in such a pocket to escape, it is preferred that pocket preferably has slanted side walls.

Preferably, the adhesive is provided as layer of essentially constant thickness.

Preferably, the adhesive layer covers the entire surface of the insulation element which is facing towards the fixation material and the base body.

A difference in the coefficients of thermal expansion of the adhesive material and the fixation material will cause mechanical strain when the electrical feedthrough assembly undergoes a change of temperature. If the electrical feedthrough assembly is used in a compressor application, temperature cycles occur which may include temperature changes from −45° C. to 80° C., from −45° C. to 120° C. or even from −55° C. to 150° C. This temperature range is also referred to as the operating temperature of the electrical feedthrough assembly. Strain exerted onto the adhesive material by the insulation element due to thermal expansion, in particular along the axial direction perpendicular to the interface of the adhesive material and the fixation material can cause separation of the adhesive material from the fixation material should thus be minimized in order to avoid gap formation.

For avoidance of delamination and thus formation of gaps between the adhesive material and the fixation material, the thickness of the adhesive material is carefully chosen to minimize the occurrence of stress or strain exerted by the insulation element onto the adhesive material. If the thickness is too large or too small, the strain exerted by the insulation element may cause the adhesive material to separate from the fixation material so that gaps may occur. The optimal thickness is dependent on possible mechanical constraints restricting lateral thermal expansion of the adhesive material. If thermal expansion is laterally constrained, the inventors have found that an adhesive material thickness chosen between 0.3 mm and 1.0 mm, preferably between 0.4 mm and 0.8 mm, minimizes strain, in particular in a direction perpendicular to the interface between the adhesive and the fixation material. If thermal expansion is not laterally constrained, the inventors have found that a thinner adhesive layer having a thickness between 0.1 mm and 0.6 mm, preferably between 0.2 mm and 0.4 mm, most preferably between 0.2 and 0.3 mm, minimizes the strain.

In order to further ensure a gap-free and preferably air-tight bond between the insulation element and the base body and/or the fixation material which is able to withstand harsh environments, it is preferred to choose the glass transition temperatures of the insulation element t_{g1} and the adhesive material t_{g2} such that a difference between the second glass-transition temperature t_{g2} and the first glass-transition temperature t_{g1} is at least 30 K, preferably at least 70 K and most preferably at least 130 K.

It has been found that choosing the difference to be at least 30 K ensures that a reliable and stable bond between the insulation element and the base body and/or the fixation material is obtained. In particular, the first glass transition temperature of the insulation element is preferably chosen to be low relative to the glass transition temperature of the rubber of the insulation element as within the desired operating temperature the insulation element should be soft in order to have a good sealing property, while the adhesive should have a high glass transition temperature relative to the glass transition temperature of the rubber in order to ensure a high resistance against different media such as oils or refrigerants.

Preferably, the first glass transition temperature t_{g1} of the insulation element is chosen such that it is lower than the operating temperature range of a device including the feedthrough assembly. Thus, a first glass transition temperature t_{g1} of at most −45° C. is preferred. This ensures that the material, in particular an elastic material, remains resilient and does not become brittle. If it is not possible to choose the first glass transition temperature t_{g1} to be lower than the lowest operating temperature, the glass transition temperature should still be chosen close to the lower bound of the operating temperature range. In such a case, it is preferred to choose the first glass transition temperature t_{g1} to be at most −10° C., more preferably at most −20° C. and most preferably at most −35° C.

Further, it is preferred to choose the second glass transition temperature t_{g2} of the adhesive material such that it is higher than the operating temperature range of a device including the feedthrough-assembly. Accordingly, a second glass transition temperature t_{g2} of at least 120° C. is preferred. This ensures that the adhesive does not exhibit significant changes in its material properties, such as the coefficient of thermal expansion, within the operating temperature range. If it is not possible to choose the first glass transition temperature t_{g2} to be higher than the highest operating temperature, the glass transition temperature should still be chosen close to the upper bound of the operating temperature range. In such a case, it is preferred to choose the second glass transition temperature t_{g2} of the adhesive such that it is higher than 50° C., more preferably higher than 70° C., especially preferably higher than 100° and most preferably higher than 115° C.

Preferably, the formed seal between the opening of the base body, the fixation material and the conductor is a hermetical seal. In particular, a feedthrough having a He leakage rate of better than 1·10⁻⁷ mbar I/s, especially 1·10⁻⁸ mbar I/s for a pressure difference of 1 bar is considered to be hermetic.

Preferably, the material of the base body is selected from a steel, especially stainless steel, most preferred structural steel, preferably microalloyed steel, most preferred structural steel in form of microalloyed steel. Microalloyed steel is a type of alloy steel that contains small amounts of alloying elements (0.05 to 0.15%), including niobium, vanadium, titanium, molybdenum, zirconium, boron and rare-earth metals. They are used to refine the grain microstructure or facilitate precipitation hardening. The yield strength of microalloyed steel is between 275 and 750 MPa without heat treatment. Weldability is good and can even be improved by reducing carbon content while maintaining strength. Fatigue life and wear resistance are superior to similar heat-treated steels. Cold-worked microalloyed steels do not require as much cold working to achieve the same strength as other carbon steel; this also leads to greater ductility. By using microalloyed steel as material, a high bending stiffness and strength could be provided.

Preferably, the second coefficient of thermal expansion α2 of the fixation material is in the range of from 4·10⁻⁶ K⁻¹ to 12·10⁻⁶ K⁻¹, within the operating temperature range of from −45° C. to 120° C., preferably from −55° C. to 150° C.

The fixation material is preferably selected from a glass, a ceramic or a glass ceramic material. Preferably, the fixation material is a glass material so that a glass-to-metal seal (GTMS) is provided between the base body, the conductor and the fixation material.

It is preferred that the fixation material is arranged such that the fixation material does not extend beyond the at least one opening in the base body, at least on the side facing towards the insulation element. In particular, a glass meniscus surrounding the conductor and extending beyond the base body should be avoided on the side facing towards the insulation element.

Arranging the fixation material such that it does not extend beyond the base body allows bending of the conductors without damaging the fixation material. For example, when a glass material is used as fixation material, a formed glass meniscus surrounding the conductor and extending beyond the opening would be subject to strong forces when the conductor is bent which could lead to cracks or damages to the glass. Thus, the proposed arrangement of the fixation material allows bending of the conductors as required. Further, the shape of such a glass meniscus is subject to strong variation making it difficult to determine the correct amount of adhesive. However, arranging of a glass meniscus on the opposite side of the base body, where the conductor is not provided with an insulation element is possible and can be used to increase an insulation or creepage distance without the need for additional elements.

Preferably, within the operating temperature range of from −45° C. to 120° C., more preferably from −55° C. to 150° C., the first coefficient of thermal expansion α1 of the adhesive material is in the range of from 20·10⁻⁶ K⁻¹ to 140·10⁻⁶ K⁻¹ for temperatures below the glass transition temperature of the adhesive material, and α1 is in the range of from 120·10⁻⁶ K⁻¹ to 200·10⁻⁶ K⁻¹ for temperatures above the glass transition temperature.

The coefficient of thermal expansion of the insulation element is less critical, as the material of the insulation element soft compared to the fixation material and can thus compensate for strain caused by temperature changes. However, it is preferred that within the operating temperature range of from 45° C. to 120° C., preferably from −55° C. to 150° C., an absolute value of the difference between the coefficient of thermal expansion of the material of the insulation element and the adhesive material is less than 100·10⁻⁶ K⁻¹, preferably less than 75·10⁻⁶ K⁻¹ and more preferably less than 50·10⁻⁶K⁻¹ and most preferably less than 25·10⁻⁶K⁻¹.

For the preferred EPDM, HNBR and FKM rubbers used as materials for the insulation element, the coefficient of thermal expansion within the operating temperature range is typically less than 100·10⁻⁶ K⁻¹ for temperatures below the glass transition temperature Tg of the rubber material.

The material of the insulation element and/or the adhesive material is/are chosen such that a reliable bond is formed which is mechanically stable, is resistant against environmental influences and is airtight.

It has been found that materials having a certain hardness and/or a certain modulus of elasticity exhibit good chemical resistance against oils and refrigerants commonly used in motor and/or compressor applications.

Preferably, the adhesive material has a Shore D hardness in the range of from 40 to 95, preferably from 58 to 90 and most preferably from 70 to 85. These relatively hard materials are preferred over “softer” materials as “harder” materials exhibit greater chemical resistance to operating media such as refrigerants and oils.

Preferably, the adhesive material has a modulus of elasticity of at least 2000 MPa, preferably at least 4000 MPa and most preferably of at least 6000 MPa.

A high hardness and a high modules of elasticity are desirable as these properties indicate a high cross-linking of the material of the insulation element. Such a high cross-linking is desirable as materials with high degrees of cross-linking are more resistant to the exposure of oils and/or refrigerants.

The insulation element is made from a resilient material, in particular a natural or synthetic rubber, in particular a fluoroelastomer (FKM), an ethylene propylene diene monomer (EPDM) rubber, a hydrogenated nitrile-butadiene rubber (HNBR) or a nitrile-butadiene rubber (NBR).

With respect to a housing of an electrical compressor, to which the electrical feedthrough assembly may be attached, the insulation element may be arranged on the side facing towards the outside of the housing. Additionally or alternatively, the insulation element may be arranged on the side facing towards the inside of the housing. In particular, the assembly may comprise at least two insulation elements, one arranged on the outside facing side and one on the inside facing side.

For example, when the proposed electrical feedthrough assembly is connected to a housing of an electric compressor, it is preferred to use a silicone rubber for an insulation element on the side of the assembly facing towards the inverter. For insulation elements facing towards the motor side, it is preferred to use a HNBR rubber.

Preferably, the adhesive material is an epoxy adhesive, an acrylate adhesive, a polyurethane adhesive or a silicone adhesive.

Preferred epoxy adhesives include amine epoxy adhesives and bisphenol F epoxy adhesives. Preferred acrylate adhesives include methyl methacrylate (MMA).

Preferably, the adhesive and/or the material of the insulation element have a specific electrical resistance of at least 1·10¹⁰ Ωcm, preferably of at least 1·10¹² Ωcm and most preferred of at least 1·10¹³ Ωcm. A high specific electrical resistance ensures that no dielectric breakdowns occur.

The material properties such as the specific electrical resistance, coefficient of thermal expansion, elasticity modulus and/or glass transition temperature may be adjusted by including one or for fillers in the respective material. Accordingly, the material of the insulation element and/or the adhesive material may comprise one or more filler materials in order to adjust at least one material property.

Preferably, the adhesive and/or the material of the insulting element comprises an inorganic filler material selected from the group comprising oxides, carbonates, and minerals. In contrast to common organic filler materials such as carbon black or soot, the selected inorganic filler materials have a higher electrical resistance. Thus, an electrical resistance is of the insulation element and/or the adhesive material is not reduced by the inclusion of the proposed filler.

Suitable inorganic filler materials include in particular silica, calcium carbonate (CaCO₃), kaolinite, talc and combinations thereof.

Preferably, the total amount of filler material in the adhesive and/or the material of the insulting element is at least 30% by weight, preferably at least 50% by weight and most preferably at least 70% by weight. This ensures that while the respective material properties can be fine-tuned and adjusted, the overall material stability is not jeopardized.

In order to ensure a good bond between the material of the insulation element and the adhesive material, a surface energy of the material of the insulation element is preferably more than 30 mN/m and most preferred at least 35 mN/m.

In particular, polar rubbers are suitable as material of the insulation element as they have good adhesion when combined with common adhesive materials such as epoxy adhesives. Nitrile-butadiene rubber and hydrogenated nitrile-butadiene rubber are polar rubber materials.

Materials having a surface energy equal to or lower than 30 mN/m are difficult to bond and are as such not preferred to be bonded with an adhesive material such as epoxy adhesives. Such materials include ethylene propylene diene monomer (EPDM) rubber which is a non-polar rubber. However, EPDM has good chemical resistance properties which makes this material desirable to be used for the insulation element.

Accordingly, for materials having by themselves a low surface energy, in particular a surface energy lower than 30 mN/m, it is preferred to activate their surface prior to forming the adhesive bond.

For example, activation of the surface to increase the surface energy to a value above 30 mN/m may include a plasma treatment such as an O₂ or atmospheric plasma treatment.

Additionally or alternatively, an adhesive material may be chosen which can overcome the low surface energy and achieve a stable and reliable mechanical bond. In particular, the adhesive is in this case preferably selected from an amine-crosslinking epoxy or a methyl methacrylate (MMA) adhesive.

Preferably, the base body, the least one conductor and the fixation material form a compression seal. Accordingly, a third coefficient of thermal expansion of the base body is preferably chosen to be larger than the second coefficient of thermal expansion of the fixation material. Preferably, for obtaining a compression seal, a difference between the third and second coefficient of thermal expansion is at least 2 ppm/K and more preferably the difference between the third and second coefficient of thermal expansion is at least 5 ppm/K. A fourth coefficient of thermal expansion of the conductor material is preferably chosen to be about equal to or less than the second coefficient of thermal expansion of the fixation material. Two coefficients of thermal expansion are considered to be about equal if the difference is less than 2 ppm/K.

Alternatively to a compression seal, the material of the base body, the fixation material and the conductor material may be chosen such that their respective coefficients of thermal expansion are about equal, wherein a difference of less than 2 ppm/K is considered to be about equal.

The conductor is made from an electrically conducting material, such as a metal material. Preferably, the at least one conductor is made from a conductive material selected from the group comprising steel, in particular stainless steel, a nickel-iron alloy, and copper. Further, the conductor may have a core made of a highly conductive core, such as copper, and a different material as outer shell.

Preferably, the cylindrical section of the insulation element has an extension portion, which extends beyond a top wall. Preferably, the extension portions sur-rounds the conductor at a distance and extends an insulation distance or creeping distance further.

The insulation sections of the insulation element, in particular the outside facing walls of a cylindrical section and/or an inside facing wall of an extension portion, if present, may be provided with ribs, ridges or grooves configured to form a form-fit connection with a connector that may be slid over the conductor to form an electrical connection. By means of the ridges or grooves, such a connector may be secured in place. Further, the ribs, ridges or grooves may provide a seal to prevent dirt or fluids from entering the space between a connector and the conductor and/or the insulation section. The ribs, rings, ridges and/or grooves can be arranged such that an annular ring or groove is formed. It is also possible to arrange set-in-rings over the outside facing wall of the extension portions and/or cylindrical sections. Such a set-in-ring may, for example, be secured in a groove arranged in the outside facing wall of the extension portion.

A further aspect of the invention relates to a method for manufacturing of such an electrical feedthrough assembly. In a first step, a base body assembly is provided. The base body assembly comprises a base body having at least one conductor embedded in fixation material that is fed through an opening of the base body providing a glass-to-metal seal (GTMS). If required, the surfaces of the base body can be cleaned or pretreated to improve adhesion.

In a subsequent second step, at least one insulation element is provided, and an adhesive is applied to a surface of the insulation element and/or the base body assembly. Depending on the selected material of the insulation element, a surface activation may be performed to increase the surface energy of the insulation element. Activation may be performed, for example, by means of a plasma treatment. Examples for suitable plasma treatments include O₂ plasma treatments and atmospheric plasma treatments.

In a subsequent third step, the insulation element is placed onto the base body such that the at least one conductor is fed through a conductor opening of an insulation section of the insulation element.

In an optional subsequent fourth step, curing of the adhesive may be performed and/or accelerated by subjecting the formed feed through to heat and/or radiation suitable for curing the adhesive.

The electrical feedthrough assembly described herein is particularly suited for use as a connection terminal for an electric compressor. The feedthrough assembly may be configured as part of a housing of the electric compressor or may be attached to a housing or a part of a housing for an electric compressor. For attachment to a housing, the base body of the electrical feedthrough assembly may include bore holes, alignment structures and/or smooth sealing areas.

Accordingly, it is a further aspect of the invention to provide an electric compressor comprising one of the electrical feedthrough assemblies described herein.

### EXAMPLES

Finite element simulations have been prepared for several example feedthrough assemblies. In all feedthrough assemblies, a base body having an opening was examined, wherein a conductor is feed through the opening. An electrically insulating fixation material holds the conductor within the opening and seals said opening. Each example feedthrough assembly further comprises an insulation element attached to the fixation material by means of an adhesive material.

In each simulation, the bonding of the insulation element to the fixation material is performed at 20° C. In each case, a thermal cycle from −45° C. to 80° C. was simulated and the highest observed value for local stress at the interface between the adhesive material and the fixation material in a direction perpendicular to the interface was recorded.

### Example 1

In the first example, an adhesive material having a Young's modulus of 3600 MPa (at −45° C.) was chosen. The first coefficient of thermal expansion of the adhesive material was set to 60·10⁻⁶ K⁻¹ and was assumed to be constant over the observed temperature cycle. An example for such an adhesive material is an epoxy adhesive. The second coefficient of thermal expansion of the fixation material was also assumed to be constant over the observed temperature cycle and was set to 10·10⁻⁶ K⁻¹. Thus, for a first run of the simulations, the difference between the coefficients of thermal expansion was set to 50·10⁻⁶ K⁻¹.

The base body and the fixation material of the example are configured to provide a pocket to receive the adhesive material. The side walls of the pocket are essentially perpendicular to a plane formed by the fixation material. Accordingly, side walls of the pocket restrict thermal expansion of the adhesive material in a lateral direction.

The material of the insulation element was chosen to have a Young's modulus of 4500 MPa (at −45° C.). An example for such a material is hydrogenated nitrile-butadiene rubber (HNBR).

In the simulation, the thickness of the adhesive material between the fixation material and the insulation element was varied in the range of from 0.05 mm to 1 mm. Additionally, for an adhesive thickness of 0.4 mm, the adhesive thickness was set to be constant and the absolute value of the difference between the first and second coefficient of thermal expansion varied in the range of from 10 ppm/K to 210 ppm/K. For each finite element simulation, the maximum local stress at the interface between the adhesive material and the fixation material in a direction perpendicular to the interface was recorded. The results of the maximum local stress in MPa are given in Table 1 below:

TABLE 1

| | | Adhesive thickness (mm) | | | | | | | |
|---|---|---|---|---|---|---|---|---|---|
| | | 0.05 | 0.1 | 0.2 | 0.3 | 0.4 | 0.6 | 0.8 | 1 |
| CTE | 10 | | | | | 51 | | | |
| difference | 50 | 247 | 99 | 73 | 59 | 54 | 45 | 38 | 32 |
| (ppm/K) | 90 | | | | | 59 | | | |
| | 130 | | | | | 74 | | | |
| | 170 | | | | | 92 | | | |
| | 210 | | | | | 109 | | | |

(Table 1, stress in MPa depending on CTE difference and adhesive thickness)

For the examined CTE difference of 50 ppm/K (50·10⁻⁶ K⁻¹), the recorded maximum stress is minimized for an adhesive thickness in the range of from 0.3 mm to 1 mm. Also, it is observed that the recorded maximum stress increases when the difference between the coefficients of thermal expansion increases.

For a CTE difference from 10 to 90 ppm/K and an adhesive thickness in the range of from 0.3 mm to 1 mm, the recorded maximum stress is minimized and is below a critical value of 70 MPa. For a thickness of 0.4 mm and more, the stress is further reduced.

### Example 2

The second examined feedthrough assembly corresponds to the feedthrough assembly of example 1, except for the properties of the adhesive material. The adhesive material of example 2 has a Young's modulus (at −45° C.) of 8600 MPa. An example for such an adhesive material is an epoxy adhesive.

For a difference of the coefficients of thermal expansion between the fixation material and the adhesive material of 50 ppm/K, a maximum local stress at the interface in a direction perpendicular to the interface of 68 MPa was observed at a temperature of −45° C. for an adhesive material thickness of 0.4 mm. The recorded maximum stress remains below 70 MPa.

### Example 3

The third examined feedthrough assembly corresponds to the feedthrough assembly of example 1, except for the design of the third example does not include a pocket for receiving the adhesive material. The adhesive material is not restricted by side walls and can freely expand also in the lateral direction.

For a CTE difference between the fixation material and the adhesive material of 50 ppm/K, the adhesive thickness was varied between 0.05 mm and 1 mm. The results for the maximum local stress at the interface in a direction perpendicular to the interface at a temperature of −45° C. is given in Table 2 below:

TABLE 2

| Thickness [mm] | 0.05 | 0.1 | 0.2 | 0.3 | 0.4 | 0.6 | 0.8 | 1 |
|---|---|---|---|---|---|---|---|---|
| Stress [Mpa] | 248 | 98 | 67 | 65 | 90 | 102 | 97 | 87 |

For an adhesive thickness in the range of from 0.2 to 0.3 mm, the recorded maximum stress is minimized and is below the critical value of 70 MPa.

### Comparative Example

The examined comparative example feedthrough assembly corresponds to the feedthrough assembly of example 1, except for the properties of the material of the insulation element. The material of the insulation element was chosen to be soft and having a Young's modulus (at −45° C.) of 6 MPa. Such soft resilient insulating materials are not resistant to harsh environments and in particular not resistant to usual refrigerant fluids and oils.

For a CTE difference between the fixation material and the adhesive material of 50 ppm/K, the adhesive thickness was varied between 0.1 mm and 1 mm. The results for the maximum local stress at the interface in a direction perpendicular to the interface at a temperature of −45° C. is given in Table 3 below:

TABLE 3

| Thickness [mm] | 0.1 | 0.2 | 0.3 | 0.4 | 0.6 | 0.8 | 1 |
|---|---|---|---|---|---|---|---|
| Stress [Mpa] | 18 | 19 | 20 | 21 | 21 | 22 | 22 |

As the material of the insulation element is very soft, the stress is acceptable for all examined thicknesses of the adhesive material. However, such a soft material which is also resistant to refrigerants, oils and other operating fluids is unavailable. The resistant resilient materials such as HNBR and EPDM are not soft enough at low temperatures, such as −45° C.

It is to be understood that the features mentioned above and those to be explained below can be used not only in the combination indicated in each case, but also in other combinations or alone, without leaving the scope of the present invention.

Preferred embodiments of the invention are shown in the figures and will be explained in more detail in the following description, wherein identical reference signs refer to identical or similar components or elements.

### BRIEF DESCRIPTION OF THE FIGURES

FIG. 1 shows an example embodiment of a feedthrough assembly comprising a base body and an insulation element in top view,

FIG. 2 shows a cross-section of the example feedthrough assembly of FIG. 1 along the line marked A-A,

FIG. 3 shows a cross-section of an example embodiment of a base body,

FIG. 4 shows a second cross-section of the base body of FIG. 3,

FIG. 5 shows a perspective view of an insulation element having three sections,

FIG. 6A shows a top view of a second embodiment of a feedthrough assembly,

FIG. 6B shows a side view with partial cross-section of the second embodiment,

FIG. 6C shows a bottom view of the second embodiment of the feedthrough assembly,

FIG. 6D shows a front view of the second embodiment,

FIG. 7 shows a third embodiment of a feedthrough assembly in a cross-sectional view, and

FIG. 8 shows a fourth embodiment of a feedthrough assembly in a cross-sectional view.

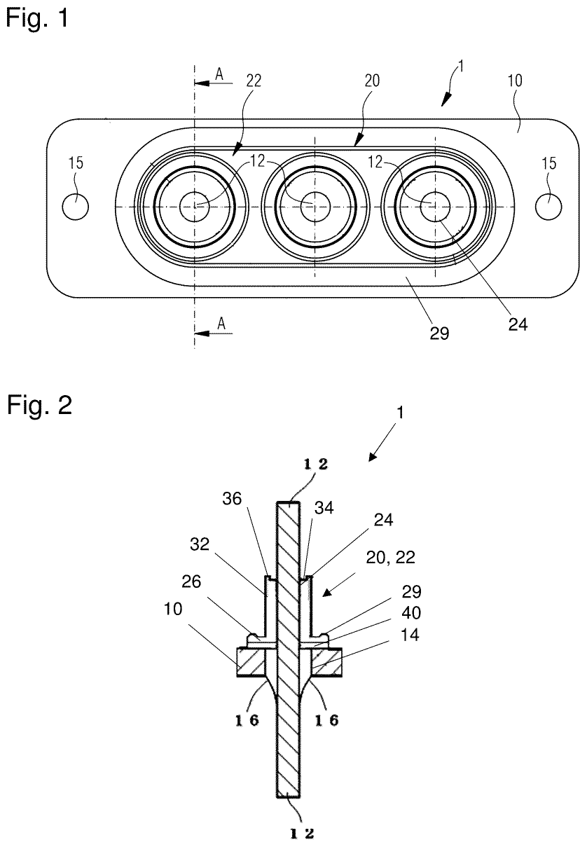

FIGS. 1 and 2 show a first exemplary embodiment of a feedthrough assembly 1. FIG. 1 shows the feedthrough assembly 1 in top view. FIG. 2 shows a cross section along a plane marked with A-A in FIG. 1. The feedthrough assembly 1 comprises a base body 10. In this exemplary embodiment, the feedthrough assembly 1 comprises three conductors 12, which are fed through the base body 10.

The base body 10 is preferably made from a metal and is configured for attachment to a housing or a part of a housing of a device such as an e-compressor (not shown). In the exemplary embodiment depicted in FIGS. 1 and 2, screw bores 15 are provided to facilitate a screw connection to a housing (not shown). Other embodiments may comprise different or additional mounting and/or alignment means for attachment of the feedthrough assembly 1 to a housing. The base body 10 as shown in FIGS. 1 and 2 is a flat piece.

As can be seen in the cross-section view of FIG. 2, each of the three conductors 12 is fed through an opening 14 in the base body 10 and is held by a fixation material 16. In the embodiment of FIGS. 1 and 2, the base body 10 has an elongated shape in which the three openings 14 are arranged along a line. Other configurations, for example where the openings 14 are evenly distributed along a circle, are also possible.

The fixation material 16 is, for example, selected from a glass and is electrically insulating. In order to further improve an electrical insulation between the base body 10 and the conductors 12, an insulation element 20 is provided. In the shown embodiment, the fixation material 16 is arranged such that it does not protrude beyond the opening 14 on the side of the base body 10 facing towards the insulation element 20. In particular, the fixation material 16 does not form a glass meniscus surrounding the conductor 12 and extending beyond the base body 10 on the side facing towards the insulation element 20. Further, in the particular embodiment shown in FIG. 2, the fixation material 16 is flush with the upper side of the base body 10. On the opposite side, the fixation material 16 protrudes from the opening 14 and forms a glass meniscus surrounding the conductor 12. Such a glass meniscus as shown in FIG. 2 can be used to provide some extension of an insulation or creepage distance. However, a further insulation element 20 could also be arranged on the opposite side the base body 10 so that one insulation element is attached to the bottom side and one is attached to the top side of the base body 10. In such a case it is preferred that the fixation material does not protrude beyond the opening 14 on both sides of the base body 10.

The insulation element 20 comprises in the shown exemplary embodiment three insulation sections 22, one for each of the conductors 12. Each of the insulation sections 22 has a cylindrical section 32, which surrounds and touches a part of the conductor 12. Further, each insulation section 22 has a top wall 34 having a conductor opening 24. The insulation element 20 is mounted to the base body 10 such that the conductors 12 are fed through the conductor openings 24. Further, as can be seen in FIG. 2, an insulation section 22 may have an extension section 34 which extends from a top wall 34 and surrounds a part of the conductor 12 in a distance.

The insulation element 20 as depicted in FIGS. 1 and 2 further comprises a sealing section 29, which is shaped like an O-ring and surrounds all insulation sections 22 of the insulation element 20. The sealing section 29 is formed as single piece together with the insulation element 20. The sealing section 29 may be used, for example, as a sealing element when the electrical feedthrough assembly 1 is mounted to a housing or a part of a housing of a device such as an e-compressor. In order to provide a good seal between the sealing section 29 and the base body 10 and/or to provide a good seal between the inner sealing section 28 and the base body 10, it is preferred to arrange a sealing area on the surface of the base body 10 in which the surface of the base body 10 is smooth and preferably free from any damages such as scratches.

For secure attachment of the insulation element 20 to the base body 10 and in order to provide additional electrical insulation, an adhesive 40 such as glue or a casting material is arranged between a bottom surface of the insulation element 20 and the fixation material 16 and a part of the base body 10. In the shown embodiment, the adhesive 40 covers the entire surface of the insulation element 20 which is facing towards the fixation material 16 and the base body 10.

In order to improve adhesion of the adhesive 40 to the base body 10, it is preferred to arrange an adhesion area on the surface of the base body 10 in which the surface of the base body 10 is roughened. The roughened surface within the adhesion area provides structures such as indentations and grooves, which increase the surface area and may even provide undercuts for improving adhesion of the adhesive 40. Further, in order to enlarge the area of the adhesive bond between the insulation element 20 and the base body 10, the insulation element 20 may have a foot section 26.

In the embodiment shown in FIGS. 1 and 2, the adhesive material 40 is not laterally restricted so that a lateral thermal expansion is possible. For such a configuration, a thickness of the adhesive material 40 of 0.1 mm to 0.6 mm has been found to minimize the amount of strain occurring due to temperature changes, in particular at the interface between the adhesive material 40 and the fixation material 16.

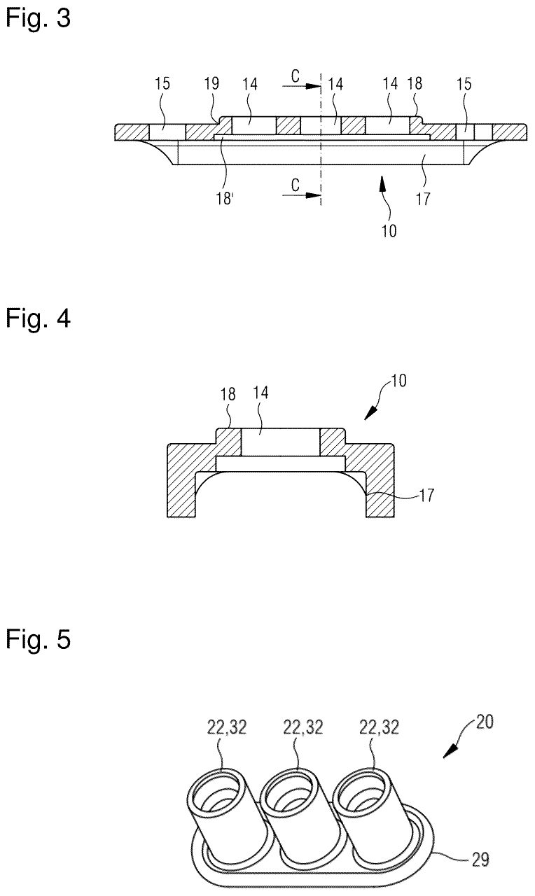

FIGS. 3 and 4 show a second embodiment of a base body 10 suitable for a feedthrough assembly 1 as described with respect to FIGS. 1 and 2. FIG. 3 shows a first cross section view from the side and FIG. 4 shows a second cross section view along the plane marked with C-C in FIG. 3. The base body 10 has an elongated shape similar to the base body 10 of the embodiment of FIGS. 1 and 2 and also has three openings 14 for allowing conductors 12, see FIGS. 1 and 2, to be fed through the base body 10.

In contrast to the base body 10 of FIGS. 1 and 2, the second embodiment of the base body 10 is not flat and comprises means for improving resistance against deformation such as bending. In the example depicted in FIGS. 3 and 4, the base body comprises pulled-up edges 17 as well as an elevated area 18 and a corresponding recess area 18′.

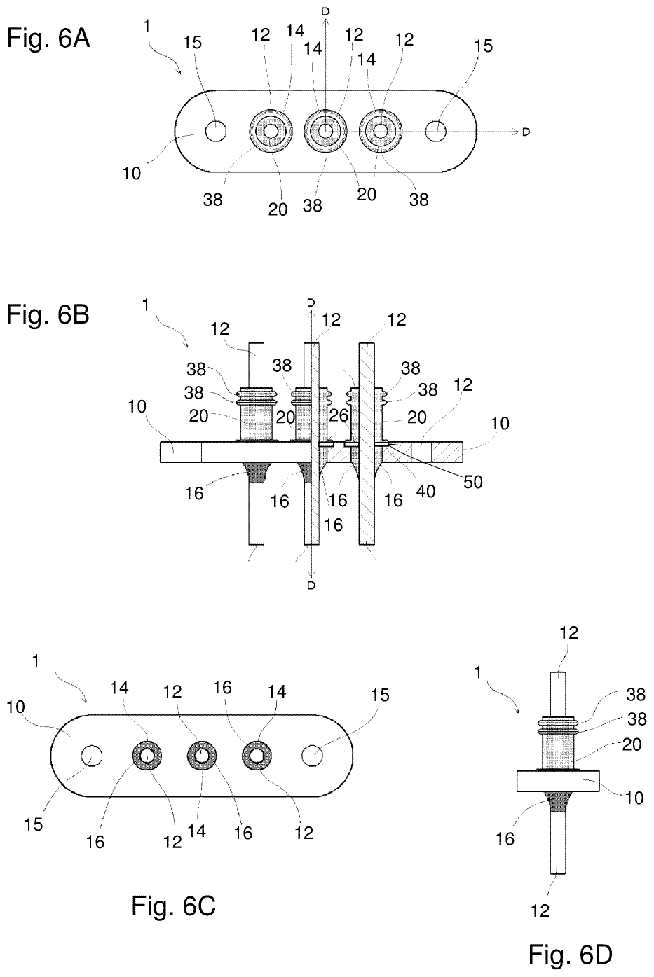

The pulled-up edges 17 extend along the long sides of the elongated shape of the base body 10 and provide increased strength against deformation of the base body 10. The elevated area 18 is in this exemplary embodiment of FIGS. 5 and 6 a single area encompassing all openings 14. In an alternative embodiment, the base body could comprise several separated elevated areas 18, wherein each of the elevated areas 18 encompasses a single one of the openings 14.

The pulled-up edges 17 as well as the elevated area 18 and corresponding recess area 18′ may be formed into a plate like precursor e.g. by means of a stamping process to form the base body 10. Such a stamping process provides for both the elevated area 18 as well as the recess areas 18′. Although by the stamping process the elevated area 18 as well as the recess area 18′ are provided, the elevated area 18 and the recess area 18′ do not necessarily have a complementary geometry. Especially the form of side walls 19 of the recess area 18′ and/or the elevated area 18 can be different. Furthermore, each of the measures, the pulled-up edges 17, the recess area 18′ as well as the elevated area 18 provide for a higher stiffness and pressure resistance of the base body 10.

FIG. 5 shows a perspective view of the insulation element 20 of the exemplary embodiment of the electrical feedthrough assembly 1 shown in FIGS. 1 and 2.

The insulation element 20 of the exemplary embodiment has three insulation sections 22 of which the cylindrical sections 32 are clearly visible in the perspective view of FIG. 5. In further embodiments, the insulation element 20 may comprise a different number of insulation sections 22, in particular one for each conductor 12. However, it is also possible to configure an insulation section 22 such that a single insulation section 22 could accommodate more than one conductor 12, for example two, three or four conductors 12.

The insulation element 20 as depicted in FIG. 5 is configured as a single piece made from an electrical insulating material. The insulation element 20 is preferably obtained as a mold part, for example by means of injection molding. In particular, all insulation sections 22 as well as the sealing section 29, see FIGS. 1 and 2, are a single piece.

Preferably, the material of the insulation element 20 is a resilient material such as a rubber material.

FIG. 6A to 6D show a second embodiment of the electrical feedthrough assembly 1, wherein FIG. 6A shows a top view, FIG. 6B shows a side view with partial cross-section, FIG. 6C shows a bottom view, and FIG. 6D shows a front view.

The second embodiment of FIGS. 6A to 6D is similar to the embodiment described with respect to FIGS. 1 and 2, but instead of a single insulation element 20 having three insulation sections 22 three insulation elements 20 are provided and attached to the base body 10. The base body 10 is in this example made from a metal and is configured for attachment to a housing or a part of a housing of a device such as an e-compressor (not shown) and comprises screw bores 15 to facilitate a screw connection to a housing (not shown). The base body 10 is a flat piece but could alternatively be configured to comprise elevations and/or depressions, just as shown in FIGS. 3 and 4.

As can be seen in the cross-section view of FIG. 6B, each of the three conductors 12 is fed through an opening 14 in the base body 10 and is held by a fixation material 16. The fixation material 16 is, for example, selected from a glass and is electrically insulating. In the embodiment of FIGS. 6A to 6D, each of the conductors 12 is provided with an insulation element 20 having a single insulation section. At least on the side facing towards the insulation elements, the fixation material 16 is arranged such that it does not protrude beyond the opening 14 on the side of the base body 10.

In the example depicted in FIGS. 6A to 6D, each of the insulation sections 22 of the insulation elements 20 are provided with annular ribs 38 configured to form a form-fit connection with a connector that may be slid over the respective conductor 12 to form an electrical connection. By means of the annular ribs 38, such a connector may be secured in place. Further, the annular ribs 38 provide a seal to prevent dirt or fluids from entering the space between a connector and the conductor 12 and/or the insulation section 22.

For secure attachment of the insulation elements 20 to the base body 10 and in order to provide additional electrical insulation, an adhesive 40 such as glue or a casting material is arranged between a bottom surface of the insulation element 20 and the fixation material 16 and a part of the base body 10. In order to enlarge the area of the adhesive bond between the insulation elements 20 and the base body 10, the insulation element 22 of FIGS. 6A to 6D have a foot section 26. In order to reduce the risk that adhesive material 40 flows onto sealing surfaces of the base body 10, the base body 10 comprises pockets 50 surrounding the respective conductor 12 for receiving the adhesive material 40.

In the embodiment shown in FIGS. 6A to 6D, the adhesive material 40 is laterally restricted by sidewalls of the pockets 50 so that a lateral thermal expansion is restricted. For such a configuration, a thickness of the adhesive material 40 of 0.3 mm to 1 mm has been found to minimize the amount of strain occurring due to temperature changes, in particular at the interface between the adhesive material 40 and the fixation material 16.

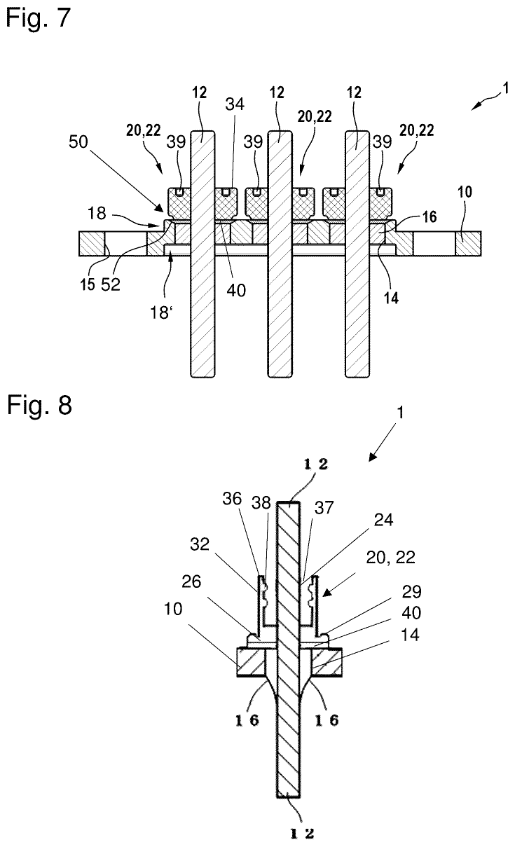

FIG. 7 shows a third embodiment of the feedthrough assembly 1 in a cross-sectional view.

The base body 10 is similar to the base body described with respect to FIG. 3 but does not feature the pulled-up edges 17. The feedthrough assembly of the third exemplary embodiment comprises three insulation elements 20, each having a single insulation section 22. Each of the insulation sections 22 is arranged to surround one of the conductors 12 in order to extend an insulation distance between the respective conductor 12 and the base body 10. In order to further enhance the insulation distance or creepage distance, the top wall 34 of the insulation sections 22 is provided with a groove 39.

The insulation elements are affixed to the fixation material 16 by means of the adhesive material 40. The fixation material 16 and a part of the base body 16 are configured to form a pocket 50 which receives the adhesive material 40. The side walls 52 of the pocket 50 serve as a barrier to prevent any excess adhesive material 40 from flowing onto other areas of the base body, in particular onto areas serving as sealing areas.

In the third exemplary embodiment, the side walls 52 of the pockets 50 are slanted or chamfered. In the depicted example, an angle between the side wall 52 and the surface of the fixation material is about 135°. Such a chamfered or slanted side wall still serves as a flow boundary and restricts lateral thermal expansion, but allows air bubbles within the adhesive material to escape.

FIG. 8 shows a fourth exemplary embodiment of the feedthrough assembly 1 which is similar to the first embodiment described with respect to FIGS. 1 and 2. The fourth embodiment differs from the first embodiment in the configuration of the insulation element 20.

The insulation element 20 of the fourth embodiment has an extension section 36 surrounding the at least one conductor 12 in a distance such that a gap 37 is formed. This gap 37 allows receiving of a connector for establishing an electrical connection with the conductor 12. Annular rings 38 are arranged on a wall of the extension section 36 facing towards the at least one conductor 12. The annular rings 38 serve as sealing means to seal the space between the insulation element 20 and the connector.

Although the present invention has been described with reference to preferred examples of embodiments, it is not limited thereto but can be modified in a variety of ways.

### LIST OF REFERENCE NUMERALS

1 electrical feedthrough assembly
10 base body
12 conductor
14 opening
15 screw bore
16 fixation material
17 pulled up edge
18 elevated area
18′ recess area
19 side wall of opening
20 insulation element
22 insulation section
24 conductor opening
26 foot section
29 seal section
32 cylindrical section
34 top wall
36 extension section
37 gap
38 annular ribs
39 groove
adhesive
50 pocket
52 side wall of pocket

1. An electrical feedthrough assembly, comprising a base body with at least one opening for a conductor embedded in a fixation material that is fed into each of the respective openings and sealing the respective opening, wherein said electrical feedthrough assembly further comprises an insulation element made from an ethylene propylene diene monomer (EPDM) rubber, or a hydrogenated nitrile-butadiene rubber (HNBR), or a nitrile-butadiene rubber (NBR), or a fluoroelastomer material (FKM), wherein the insulation element is affixed by an adhesive material arranged between the insulation element and the fixation material and optionally between the insulation element and the base body, wherein the adhesive material is electrically insulating, wherein within an operating temperature range of from −45° C. to 120° C., an absolute value of a difference between a first coefficient of thermal expansion α1 of the adhesive material and a second coefficient of thermal expansion α2 of the fixation material is in the range of from 10·10⁻⁶ K⁻¹ to 180·10⁻⁶ K⁻¹, and wherein when
i) the adhesive material is laterally enclosed by a sidewall, the lateral expansion of the adhesive material is restricted, and the adhesive material has a thickness of between 0.3 mm and 1.0 mm, and when
ii) the adhesive material is not laterally enclosed by a sidewall, the lateral expansion of the adhesive material is possible, and the adhesive material has a thickness of between 0.1 mm and 0.6 mm.

2. The electrical feedthrough assembly according to claim 1, wherein a pocket for the adhesive material having a side wall is defined by the base body and the fixation material, wherein the side wall is a slanted side wall.

3. The electrical feedthrough assembly according to claim 1, wherein a first glass transition temperature t_{g1} of the insulation element is at most 0° C. and/or wherein a second glass transition temperature t_{g2} of the adhesive material is higher than 50° C. and/or
wherein a difference between a second glass-transition temperature t_{g2} and a first glass-transition temperature t_{g1} is at least 30 K.

4. The electrical feedthrough assembly according to claim 1, wherein within the operating temperature range from −45° C. to 120° C., the first coefficient of thermal expansion α1 of the adhesive material is in the range of from 20·10⁻⁶ K⁻¹ to 140·10⁻⁶ K⁻¹ for temperatures below the glass transition temperature of the adhesive material, and α1 is in the range of from 120·10⁻⁶ K⁻¹ to 200·10⁻⁶ K⁻¹ for temperatures from the glass transition temperature and/or wherein the second coefficient of thermal expansion α2 of the fixation material is in the range of from 4·10⁻⁶ K⁻¹ to 12·10⁻⁶ K⁻¹.

5. The electrical feedthrough assembly according to claim 1, wherein the adhesive material has a Shore D hardness of from 40 to 95.

6. The electrical feedthrough assembly according to claim 1, wherein the adhesive material has a modulus of elasticity of at least 2000 MPa.

7. The electrical feedthrough assembly according to claim 1, wherein the material of the base body is steel.

8. The electrical feedthrough assembly according to claim 1, wherein the fixation material is a glass.

9. The electrical feedthrough assembly according to claim 1, wherein the adhesive material is an acrylate adhesive, a polyurethane adhesive, a silicone adhesive, or an epoxy adhesive.

10. The electrical feedthrough assembly according to claim 1, wherein the adhesive material and/or the material of the insulation element have a specific electrical resistance of at least 1·10¹⁰ Ωcm.

11. The electrical feedthrough assembly according to claim 1, wherein the adhesive material and the material of the insulting element comprises an inorganic filler material.

12. The electrical feedthrough assembly according to claim 11, wherein the total amount of filler material in the adhesive material and the material of the insulting element is at least 30% by weight.

13. The electrical feedthrough assembly according to claim 1, wherein a surface energy of the material of the insulation element is at least 22 J/m.

14. The electrical feedthrough assembly according to claim 1, wherein a difference between a third coefficient of thermal expansion α3 of the base body and the second coefficient of thermal expansion α2 of the fixation material is less than 2 ppm/K.

15. The electrical feedthrough assembly according to claim 1, wherein the base body, the conductor and the fixation material form a compression seal, and wherein a difference between a third coefficient of thermal expansion α3 of the base body and the second coefficient of thermal expansion α2 of the fixation material is at least 2 ppm/K.

16. The electrical feedthrough assembly according to claim 1, wherein the insulation element has a cylindrical section surrounding the conductor, wherein grooves and/or annular rings are arranged on the cylindrical section, and/or wherein the insulation element has an extension section surrounding the conductor in a distance such that a gap is formed, wherein grooves and/or annular rings are arranged on the wall of the extension section facing towards the conductor.

17. An electric compressor comprising an electrical feedthrough assembly according to claim 1.

18. The electrical feedthrough assembly according to claim 3, wherein a first glass transition temperature t_{g1} of the insulation element is at most at most −10° C.; and/or
wherein a second glass transition temperature t_{g2} of the adhesive material is higher than 70° C.; and/or
wherein a difference between a second glass-transition temperature t_{g2} and a first glass-transition temperature t_{g1} is at least 70 K.

19. The electrical feedthrough assembly according to claim 18, wherein a first glass transition temperature t_{g1} of the insulation element is at most −25° C. and/or
wherein a second glass transition temperature t_{g2} of the adhesive material is higher than 100° C. and/or
wherein a difference between a second glass-transition temperature t_{g2} and a first glass-transition temperature t_{g1} is at least 130 K.

20. The electrical feedthrough assembly according to claim 9, wherein the adhesive material is an epoxy adhesive selected from an amine epoxy or a bisphenol F epoxy.
